(19) United States
(12) Patent Application Publication
(10) Pub. No.: US 2005/0138855 A1
(43) Pub. Date: Jun. 30, 2005

(54) Animated gamebird decoy with movable appendages

(76) Inventor: Garry Lee Jensen, Nekoosa, WI (US)

Correspondence Address: Garry Lee Jensen, 114 Cedar Street, Nekoosa, WI, 54457, US

(21) Appl. No.: 10/854,994

(22) Filed: Aug. 21, 2003

(51) Int. Cl. A01M 31/06

(52) U.S. Cl. 43/3

(57) ABSTRACT

An animal decoy apparatus made from a plastic shelled gamebird decoy converted to an animated decoy whereas the two wing-like appendages move up and down in a flapping motion. An electric actuator is mounted to the frame within the chamber formed by the body of the decoy. The electric actuator is battery powered. When the actuator is energized the actuator plunger moves downward forcing the distal ends of the appendages down also causing the proximal ends of the appendages upward. When the power supply is interrupted the plunger mechanism is forced upward by the weight of the appendages causing the proximal ends to come down. Between the battery and the actuator is an intermittant device causing an interruption in power causing the appendages to move up and down simulating the wing flapping movements of a gamebird.

### REFERENCES CITED

U.S. Pat. Docs.

| | | | |
|---|---|---|---|
| 378,410 | February 1888 | Trimble | 43/3 |
| 547,553 | October 1895 | Keller | 43/3 |
| 1,831,286 | November 1931 | Chelini | 43/3 |
| 2,013,709 | September 1935 | Boissoneau | 43/3 |
| 2,413,418 | December 1946 | Rulison | 43/3 |
| 2,480,390 | August 1949 | Thompson | 43/3 |
| 2,575,252 | November 1951 | Berger | 43/3 |
| 2,576,209 | November 1951 | Berger | 43/3 |
| 2,691,233 | October 1954 | Richardson | 43/3 |
| 2,835,064 | May 1958 | Webb | 43/3 |
| 3,689,927 | September 1972 | Boston | 43/3 |
| 3,916,553 | November 1975 | Lynch | 43/3 |
| 4,128,958 | December 1978 | Snow | 43/3 |
| 4,172,335 | October 1979 | Farmer. | |
| 4,322,908 | April 1982 | McCrory | 43/3 |
| 4,611,421 | September 1986 | Jacob. | |
| 4,753,028 | June 1988 | Farmer. | |
| 4,885,861 | December 1989 | Gazalski. | |
| 4,928,418 | May 1990 | Stelly. | |
| 5,036,614 | August 1991 | Jackson | 43/3 |
| 5,168,649 | December 1992 | Wright | 43/3 |
| 5,172,506 | December 1992 | Tiley et al. | |
| 5,231,780 | August 1993 | Gazalski | 43/3 |
| 5,233,780 | August 1993 | Overholt | 43/2 |
| 5,289,654 | March 1994 | Denny | 43/2 |
| 5,377,439 | January 1995 | Roos | 43/3 |
| 5,459,958 | October 1995 | Reinke | 43/2 |
| 5,636,466 | June 1997 | Davis | 43/3 |
| 5,809,683 | September 1998 | Solomon | 43/3 |
| 5,862,619 | January 1999 | Stancil | 43/3 |
| 5,884,427 | March 1999 | Lenz | 43/2 |
| 5,930,969 | August 1999 | Parr et al | 43/3 |
| 5,974,720 | November 1999 | Bowling | 43/3 |
| 6,092,323 | June 2000 | McBride et al | 43/3 |

FOREIGN PATENT DOCUMENTS

| | | | |
|---|---|---|---|
| 264,313 | April 1929 | Italy | 43/2 |

### BACKGROUND OF THE INVENTION

1. Field of the Invention

The present invention relates generally to devices for attracting game animals and more particularly to waterfowl decoys especially adapted for attracting game animals.

2. Description of the Prior Art

When hunting animals, hunters often deploy devices whose function is to attract the animals that are being hunted. Most decoys do not have any movement to them. It would be favorable to have some movement since real live animals move when feeding. Of special interest are decoys which simulate ducks and geese. In the prior art, waterfowl decoys which have moveable wings were mechanically flapped by pulling a string or cord, or have wings that spin or rotate. There are many limitations with pulling a string, and spinning or rotating wings are unnatural movements.

Throughout the years, a number of innovations have been developed relating to waterfowl decoys. The following U.S. patents are representative of some of those innovations. U.S. Pat. Nos. 4,172,335; 4,611,421; 4,753,028; 4,485,873; 4,885,861; 4,928,418; 5,172,506; 5,231,780; 5,636,466. Some patents disclose waterfowl decoys that move in the wind, but as we all know, we cannot rely on the wind to give our decoys motion. In this respect it would be desirable for the decoy to move without depending on the wind.

It is therefore, an object of the present invention to provide movement electrically causing the two wing-like appendages to flap up and down rather than to rely on the wind.

It is a further object of the present invention to produce the up and down motion of the two wing-like appendages using an electric actuator that goes up and down instead of an electric motor that spins the wing-like appendages horizontally which is an unnatural movement.

Likewise, it is an object of the present invention to provide an inexpensive, easy to make and operate waterfowl decoy that the average hunter can afford and still have one that has natural movement.

### SUMMARY OF THE INVENTION

One embodiment of the present invention is a plastic shelled gamebird decoy comprising of a frame (the stake that comes with the purchased decoy) with a vertical and a horizontal axis, and a simulated waterfowl body mounted to said frame and defining a chamber, with an electric actuator located within this said chamber being afixed to the vertical stake of the frame being connected to a source of electrical energy that makes the plunger on the actuator move up and down. Down being energized and up when deenergized. The plunger on the actuator is raised back up by the weight of the two wing-like appendages. An intermittent device (such as a flasher relay for an automobiles turn signal or emergency flashers) is situated between the actuator and the power source (battery). This device is attached to the positive wire of the actuator which is afixed to the vertical stake frame inside the chamber formed by the plastic shelled gamebird decoy. When the actuator is energized this causes the plunger on the actuator to be pulled down. The two wing-like appendages are pinned to two mounting brackets that are afixed to the horizontal stake frame. The two wing-like appendages proximal ends protrude through the opposite sides of the plastic shelled gamebird decoy through an elongated hole as to allow the proximal ends to move in an up and down motion simulating a live waterfowl gamebird flapping its wings.

The two distal ends of the two wing-like appendages are underneath a bracket which is afixed to the actuators plunger mechanism of the electric actuator. When the actuator is energized the plunger on the actuator is pulled down forcing the distal ends of the two wing-like appendages also. This downward motion will cause the two proximal ends of the two wing-like appendages in an upward motion in relation to the downward motion of the distal ends because the two wing-like appendages are pinned close to the distal ends. When the electric actuator is deenergized the weight of the two wing-like appendages will force the plunger on the actuator back up into the extended position.

The two wing-like appendages are made of a cloth or some sort of plastic sheeting that is attached to the proximal ends of the two wing-like appendages as soon as it exits the sides of the plastic shelled gamebird decoy. This sheeting will simulate the wings and feathers of the preferred gamebird and will be afixed to the appendages so they look natural.

Yet another embodiment of the present invention is to use an outside power source such as a battery (electrical) energy to achieve the flapping wing motion of real live waterfowl gamebirds for use in the sport of hunting.

### BRIEF DESCRIPTION OF THE DRAWINGS

FIG. 1 is a quartering side perspective view illustrating the waterfowl decoy apparatus of the present invention in position with the wing-like appendages flapping in a field.

FIG. 2 is a quartering frontal view illustrating the waterfowl decoy apparatus shown in FIG. 1 with the wing-like appendages in the up position.

FIG. 3 is a cross-sectional frontal view of the waterfowl decoy apparatus illustrating the components disposed within the interior of the decoy housing.

FIG. 4 is a quartering frontal view of the waterfowl decoy apparatus illustrating the components disposed within the interior of the decoy housing with the actuator in the down position.

FIG. 5 is a quartering frontal view of the waterfowl decoy apparatus illustrating the components disposed within the interior of the decoy housing with the actuator in the up position.

FIG. 6 is an exploded quartering frontal view of the waterfowl decoy apparatus illustrating all of the components disposed within the interior of the decoy housing.

FIG. 7 is an exploded view of brackets 23A & 23B that are attached to the horizontal frame stake.

FIG. 8 is a view of the dowels 34A & 34B that makeup the wing-like appendages showing the holes 33A & 33B in which the cotter pins 32A & 32B pin the dowels to brackets 23A & 23B.

FIG. 9 is a view of the wing-like appendages that flap up and down when the actuator is activated.

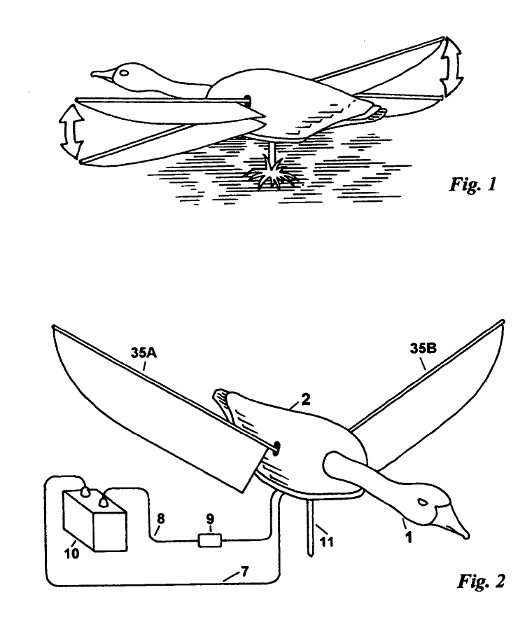

### DETAILED DESCRIPTION OF THE INVENTION

Referring now to the drawings, the waterfowl decoy apparatus is constructed in accordance with the present invention includes a decoy housing 2 having the configuration of a waterfowl's body and defining an inside chamber. The waterfowl decoy housing may be constructed of any suitable material such as plastic or fiberglass. A shell decoy of this type is described in U.S. Pat. No. 4,885,861 issued to R. S. Gazalski, the description of which is incorporated herein in its entirety by reference. The head and neck assembly 1 shown comes with the decoy body. The actuator 3 is a purchased 12 volt automobile door lock actuator.

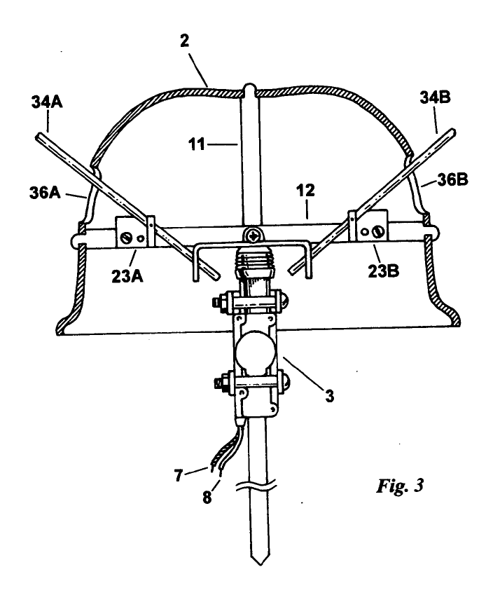

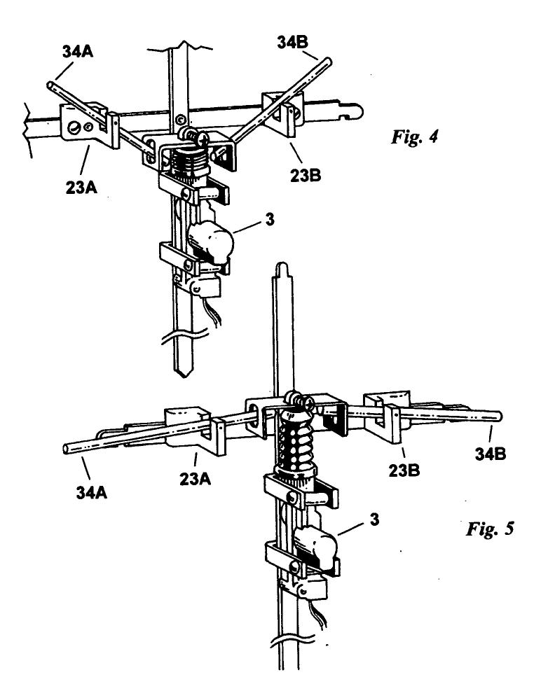

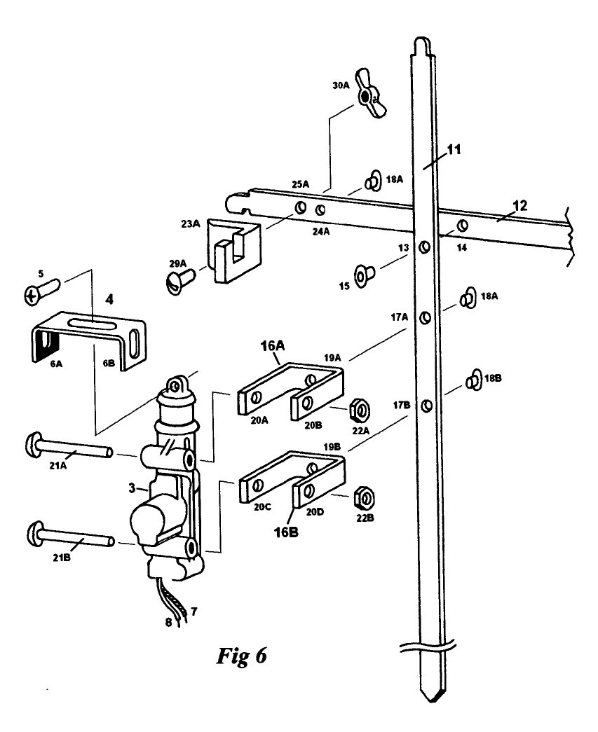

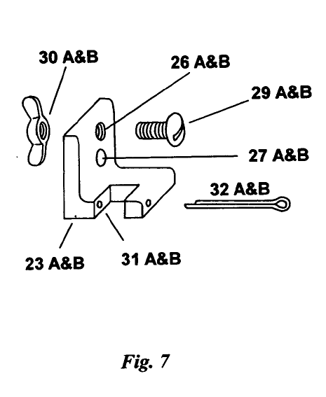

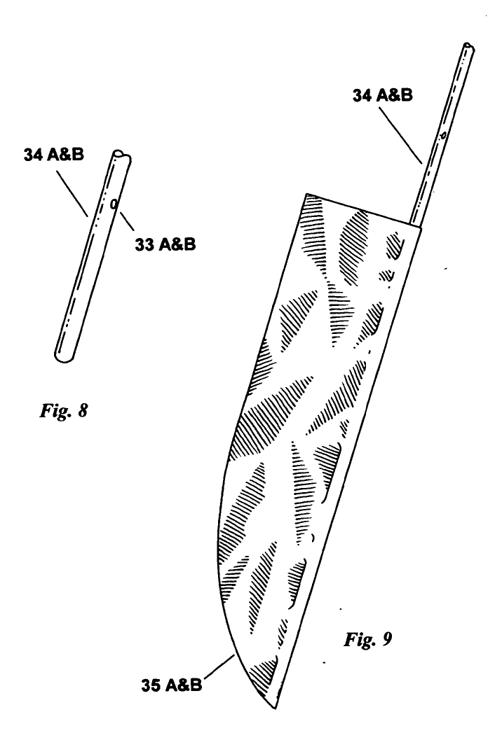

Referring to FIG. 3 the vertical stake 11 and the horizontal stake 12 are also parts of the purchased decoy. The bracket 4 on top of the actuator is held in place by a bolt 5. As seen in FIG. 6 the said bracket has two elongated holes 6A&B in which the two wing-like appendages 35A&B as seen in FIG. 2 pass through. These two wing-like appendages move up and down when the electrical power is supplied as shown in FIG. 2 by a battery 10 as the current passes through an intermittant device 9 which is a flasher relay for an automobiles turn signal assembly. These wing-like appendages pass through the decoy shell through two elongated holes 36A&B as shown in FIG. 3. When the power is supplied to the actuator the plunger on the actuator is pulled down forcing the distal ends of the two dowels 34A&B down also since the said dowels are cotter pinned see FIG. 7 by two cotter pins 32A&B through holes 31A&B that are through the two dowels. These two dowels are attached to two brackets 23A&B which in turn are attached to the horizontal stake 12 by two bolts 29A&B that are threaded through two holes 26A&B in the two brackets and two holes 25A&B that are through the horizontal stake 12 attached by two wing nuts 30A&B see FIG. 6. Also through these two brackets are two holes 27A&B in which two rivets 28A&B pass through two other holes 24A&B through the horizontal stake see FIG. 6 and are pop riveted through the two said holes in the horizontal stake only. These two rivets just rest inside the two holes 27A&B in the bracket so as to just stabilize the bracket onto the horizontal stake. Since the proximal ends of the two wing-like appendages are much heavier than the distal ends, the weight of the proximal ends force the plunger on the actuator back up into the extended position.

Referring to FIG. 6 the said actuator is attached to two brackets 16A&B by two bolts 21A&B that go through four holes 20A&B&C&D and are secured by two nuts 22A&B. The said brackets are riveted to the vertical stake frame by two rivets 18A&B. These two rivets go through two holes 19A&B in said brackets and through two holes 17A&B in the vertical stake frame. The vertical and horizontal stake frames are riveted together with a pop rivet 15 that passes through a hole 13 in the vertical stake frame and a hole 14 in the horizontal stake frame.

Referring to FIG. 9 the two wing-like appendages are made from two dowels 34A&B and two pieces of plastic sheeting 35A&B that are attached to the two dowels as to look like the real wings of a waterfowl gamebird.

Referring to FIG. 3 is the two wires that go to the battery from the actuator. Wire 8 is the positive wire and wire 7 is the negative wire.

1. An animal decoy apparatus, comprising:
a frame with a vertical and a horizontal axis;
a simulated gamebird body mounted to said frame and defining a chamber;
an electrical actuator located within said chamber being connectable to a source of electrical energy and having a movable output;
a pair of wing-like appendages movably mounted on said horizontal frame within said chamber formed by a simulated gamebird body,
connecting means extending within said chamber between said movable output and said wing-like appendages and operable to move said appendages when said electrical actuator is connected to a source of electrical energy; and wherein:
said wing-like appendages are afixed to brackets which are afixed to the horizontal frame within said chamber formed by the simulated gamebird body,
an intermittant electrical device installed between the electrical actuator and the connectable power source;
an electrical actuator is mounted to said vertical frame within said chamber formed by the simulated gamebird body by two brackets which are attached to said vertical frame;
a pair of brackets afixed to the horizontal frame within said chamber formed by the simulated game-bird body to which the two wing-like appendages are pinned to;
a bracket attached to the top of the plunger of said electrical actuator within said chamber formed by the simulated gamebird body,
an electric actuator is mounted to the vertical frame of the simulated gamebird body within said chamber with the distal ends of the two wing-like appendages under said bracket that is attached to said plunger of the actuator. When the actuator plunger is in the extended or up position with the distal ends under the bracket that is attached to the plunger, the proximal ends of the two wing-like appendages extend through elongated holes on opposite sides of the simulated gamebird body. When the actuator is energized the plunger is pulled down forcing the distal ends down also. Since the two wing-like appendages are pinned to said brackets that are afixed to said horizontal frame within the chamber, this downward motion causes the proximal ends upward. When the actuator is deenergized because of the said intermittant device the weight of the proximal ends of the said wing-like appendages will force the plunger back upward into the extended position. This process is repeated everytime the actuator is energized and then deenergized by the intermittent device causing the two wing-like appendages to flap up and down in a real wing-like motion.
